(19) United States
(12) Patent Application Publication
(10) Pub. No.: US 2025/0084822 A1
(43) Pub. Date: Mar. 13, 2025

(54) REMOTE-CONTROLLED MODULAR HYDROPOWER GENERATOR SYSTEM

(71) Applicant: CHANG-YU CHEN, Hualien City (TW)

(72) Inventor: CHANG-YU CHEN, Hualien City (TW)

(21) Appl. No.: 18/825,233

(22) Filed: Sep. 5, 2024

Related U.S. Application Data
(60) Provisional application No. 63/581,001, filed on Sep. 7, 2023.

(51) Int. Cl. F03B 15/12

(52) U.S. Cl. CPC F03B 15/12; F05B 2220/706; F05B 2230/80; F05B 2260/4021; F05B 2260/4022

(57) ABSTRACT

A remote-controlled modular hydropower generator system, comprising: a turbine module, a gear box module, a transmission module, a power generator module, a monitoring module, and a wireless communication module. The wireless communication module can transmit hydropower generator data from the monitoring module to a remote control module, enabling real-time monitoring of the hydropower generator data from the power generator module. The remote control module can send control commands to the monitoring module through the wireless communication module to control the power generator module. The turbine housing is securely fastened using two main frames and an intermediate divider, allowing for quick disassembly, maintenance, or replacement of the turbine and gear box module. The transmission module and the power generator module are locked on the outer sides of the two main frames, facilitating fast disassembly, maintenance, or replacement of the transmission module and the power generator module.

### CROSS-REFERENCE TO RELATED PATENT APPLICATION

This non-provisional application claims priority to and the benefit of U.S. Provisional Application No. 63/581,001, filed Sep. 7, 2023, the disclosure of which is incorporated herein in its entirety by reference.

### BACKGROUND OF THE INVENTION

### Field of the Invention

A remote-controlled modular hydropower generator system, particularly referring to a system equipped with remote control functionality, real-time monitoring capability, and the ability to be configured with various modules to adapt to different locations. It offers the advantages of quick maintenance and convenient servicing.

### Description of the Prior Art

In the past, small-scale hydropower systems have indeed faced several challenges in their development and application. These challenges include technical, environmental, and stability-related issues. Designing and manufacturing efficient, reliable, and cost-effective equipment for micro-hydropower generator has been a significant concern. However, known micro-hydropower systems have suffered from low efficiency, high failure rates, and expensive maintenance costs.

These problems may be influenced by environmental factors since micro-hydropower systems typically rely on water flow. Matching and applying such systems in various locations can be difficult, often leading to mismatches between the micro-hydropower system and the specific site, resulting in poor power generator efficiency or unstable performance. Inadequate real-time monitoring and supervision of the system can lead to equipment damage, especially in harsh environmental conditions, accelerating equipment aging and increasing the failure rate.

Constructing micro-hydropower systems usually requires a certain level of financial investment, which can be challenging for communities with limited resources in small or rural areas. Apart from construction costs, the expenses associated with maintenance and operation may also become problematic. Consequently, in the past, it was common for locations to abandon the construction of hydropower systems due to insufficient funding or inadequate power generator benefits during the planning phase.

### SUMMARY OF THE INVENTION

In order to address the pain points in the development and application of the industry mentioned above, the present invention is a remote-controlled modular hydropower generator system. It comprises: a modular turbine, which includes a turbine module with a turbine casing having an internal turbine chamber connected to an inlet pipe, and a turbine shaft inside the turbine chamber. The turbine shaft extends outside the turbine casing, and the turbine has multiple blades. The bottom of the turbine casing has a drain outlet. The system also includes a gear box module, positioned inside the turbine casing and separated from the turbine chamber by a gear set; a transmission module placed outside the turbine casing, consisting of a first pulley and a second pulley. The first pulley is connected to the turbine shaft and located outside the turbine casing, while the second pulley is appropriately positioned outside the turbine casing, corresponding to the gear box module, and is axially connected to the gear box module through a drive member. Furthermore, there is a power generator module placed outside the turbine casing, positioned opposite the second pulley, and axially connected to the gear box module. A monitoring module is electrically connected to the power generator module of the modular turbine to collect hydropower generator data. Additionally, a wireless communication module is electrically connected to the monitoring module, which can transmit hydropower generator data to a remote control module. The remote control module can monitor real-time hydropower generator data from the power generator module and send control commands to the monitoring module through the wireless communication module, controlling the power generator module. The turbine casing is locked securely through two main frames and an intermediate divider, facilitating rapid disassembly or replacement of the turbine and gear box module. The transmission module and the power generator module are locked on the outer sides of the two main frames, allowing fast disassembly or replacement of the transmission module and the power generator module.

The main technical means of the present invention utilize part modularity and a well-disassembled design. The turbine casing is securely locked by two main frames and an intermediate divider, enabling quick disassembly or replacement of the turbine and gear box module. The transmission module and the power generator module are locked on the outer sides of the two main frames, facilitating fast disassembly or replacement of the transmission module and the power generator module. During environmental testing, different specification modules can be quickly configured and installed to meet the usage environment.

The secondary technical means of the present invention utilize the monitoring module and the wireless communication module to achieve remote monitoring and control. Hydropower generator status or system status can be monitored using mobile apps or computer applications. In case of abnormalities or errors, the power generator module can be quickly shut down through mobile apps or computer applications to minimize equipment damage. The present invention can also connect the hydro generator power to the electrical grid or power storage module through parallel operation. This allows the hydro generator power to be transferred to the internal or external electrical grid, and users can also be informed of the hydro power generator data through mobile phones, computers, or mobile devices.

### BRIEF DESCRIPTION OF THE DRAWINGS

FIG. 1 is a system block diagram of the present invention;

FIG. 2 is an exploded view of the modular turbine of the present invention;

FIG. 3 is an implementation diagram of the present invention; and

FIG. 4 is a cross-sectional view of the modular turbine of the present invention.

### DESCRIPTION

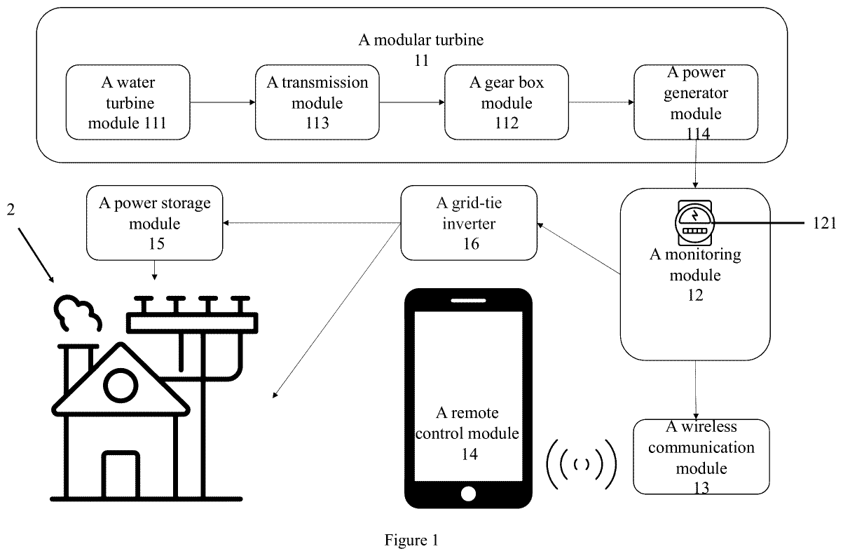

Please refer to FIG. 1. FIG. 1 depicts the block diagram of the present invention, which is a remote-controlled modular hydropower generator system (1). It includes a modular turbine (11) consisting of a water turbine module (111), a gear box module (112), a transmission module (113), and a power generator module (114). The power generator module (114) is electrically connected to a monitoring module (12) used to collect hydropower generator data from the power generator module (114). There is also a wireless communication module (13) electrically connected to the monitoring module (12). The wireless communication module (13) can transmit the hydropower generator data from the monitoring module (12) to a remote control module (14). The remote control module (14) can monitor real-time hydropower generator data of the power generator module (114) and send control commands back to the monitoring module (12) through the wireless communication module (13). In this illustration, the remote control module (14) is represented as a smartphone, and the wireless communication module (13) is a mobile communication module. However, the remote control module (14) could also be other electronic devices with remote control capabilities, such as tablets or computers. The wireless communication module (13) can also be a WIFI communication module. Additionally, the monitoring module (12) includes a multifunctional electricity meter (121) that provides additional hydropower generator data, such as voltage (V), current (A), power (KW), and energy (KWH), which can be monitored in real-time by the remote control module (14).

The diagram also reveals the transmission method within the modular turbine (11). When water flows through the water turbine module (111), it drives the transmission module (113). The transmission module (113), in turn, drives the gear box module (112), which can regulate the rotational speed of the power generator module (114) to achieve high-efficiency power generator. Different combinations of the modules can be configured according to various field conditions to create the highest efficiency power generator system for each specific site. In this illustration, the monitoring module (12) uses a grid-tie inverter (16) to convert the DC power generated by the power generator module (114) into AC power and send it to the power grid (2). The power generator module (114) can also be an AC generator, and the monitoring module (12) can use a transformer to transmit the AC power generated by the power generator module (114) to the power grid (2). Furthermore, the monitoring module (12) can store the power in a power storage module (15) through the grid-tie inverter (16) for emergency backup power, which can then be transmitted to the power grid (2). This setup is suitable for water operators, providing emergency power in case of a power outage.

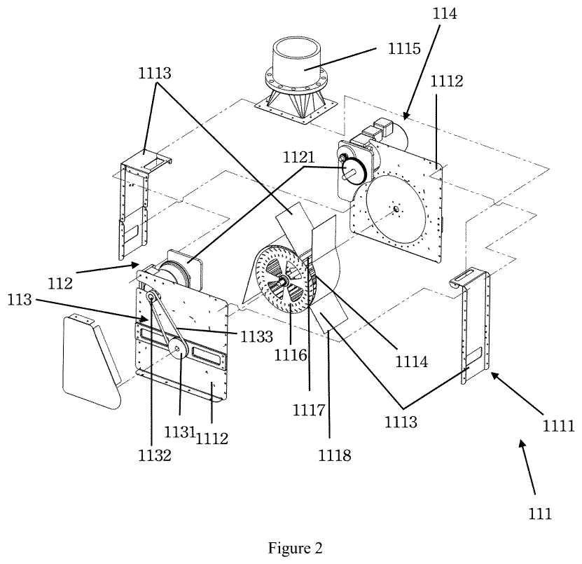

Please refer to FIG. 2. FIG. 2 is an exploded view of the modular turbine (11) of the present invention. It reveals the structure of the water turbine module (111), which consists of a water turbine housing (1111). The water turbine housing (1111) is formed by locking two main frames (1112) together with an intermediate divider (1113) between them. Inside the water turbine housing (1111), there is a water turbine chamber (1114) connected to an inlet pipe (1115). The water turbine chamber (1114) houses a water turbine (1116) with multiple blades (1117). At the bottom of the water turbine housing (1111), there is a drain outlet (1118). The gear box module (112) with a gear set (1121) is located inside the water turbine housing (1111) and separated from the water turbine chamber (1114). The transmission module (113) is located outside the water turbine housing (1111) and consists of a first pulley (1131) and a second pulley (1132). The first pulley (1131) is axially connected to the water turbine (1116) and located outside the water turbine housing (1111). The second pulley (1132) is placed at an appropriate position outside the water turbine housing (1111) relative to the gear box module (112), and it is axially connected to the gear box module (112). The first pulley (1131) and the second pulley (1132) are connected by a transmission component (1133). The power generator module (114) is located outside the water turbine housing (1111) and faces the second pulley (1132). It is axially connected to the gear box module (112). In this embodiment, the transmission component (1133) in the modular turbine (11) can be a transmission belt. According to the requirements, a transmission belt adjuster can be further installed. In other environments, the first pulley (1131) and the second pulley (1132) can be gears, and the transmission component (1133) can be a transmission chain. For locations with higher water flow rates, more robust and weather-resistant transmission chains and gears can be selected to reduce the failure rate.

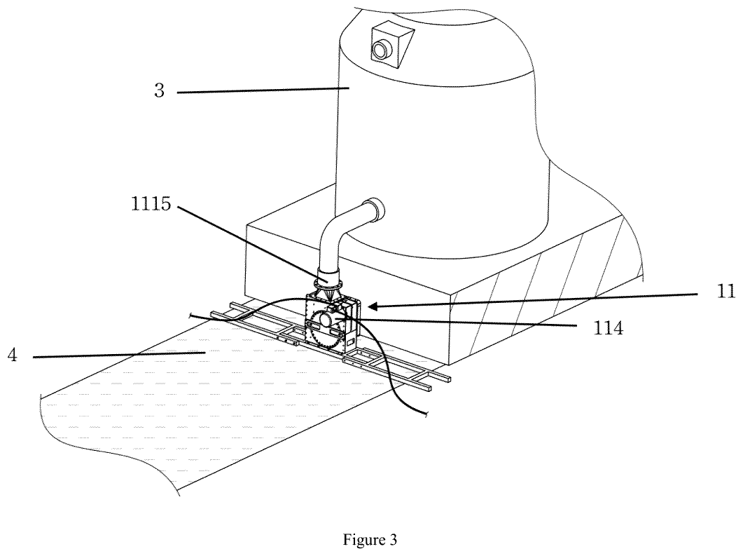

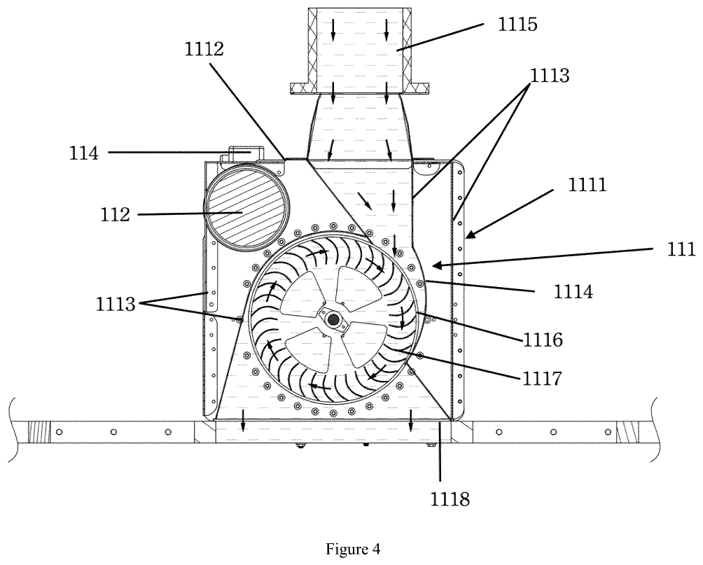

Please also refer to FIG. 3 and FIG. 4. FIG. 3 is an embodiment of the present invention, illustrating its application in an aquaculture environment or a water treatment environment. Water from the source (3) enters the inlet pipe (1115) and flows into the water pool (4). The power generator module (114) connects with the wiring to guide the electricity to the monitoring module, as shown in FIG. 1. Subsequently, the electricity can be fed into the power grid (2) or even sold back to the power company.

When water from the source (3) enters the inlet pipe (1115) and flows into the water turbine chamber (1114), it drives the water turbine (1116), which is coaxial with the first pulley (1131). Therefore, the transmission component (1133) drives the second pulley (1132). The second pulley (1132) is axially connected to the gear box module (112). When the second pulley (1132) rotates (not shown in this diagram, please refer to FIG. 2), it drives the gear box module (112), which, in turn, regulates the power generator module (114) for power generator. After driving the water turbine (1116), the water flows into the water pool (4) through the drain outlet (1118).

Returning to FIG. 1, the wireless communication module (13) can transmit the hydropower generator data from the monitoring module (12) to a remote control module (14). The remote control module (14) can monitor real-time hydropower generator data of the power generator module (114) and send control commands back to the monitoring module (12) through the wireless communication module (13). This enables the realization of a remote-controlled modular hydropower generator system.

Through this invention, a remote-controlled modular hydropower generator system can be achieved. It features low maintenance costs, high power generator efficiency, environmental friendliness, and adaptability to different hydropower generator sites. It reduces development costs, promotes hydropower utilization, minimizes pollution, and contributes to sustainable development across various fields and our planet.

What is claimed is:

1. A remote-controlled modular hydropower generator system, which includes:
a modular turbine, comprising:
a water turbine module with a water turbine housing formed by locking and fixing two main frames and an intermediate divider, wherein the water turbine housing contains a water turbine chamber connected to an inlet pipe, inside the water turbine chamber, there is a water turbine with multiple blades, the axis of the water turbine passes through the water turbine housing, and there are drain outlets at the bottom of the water turbine chamber;
a gear box module with a gear set, located inside the water turbine housing and separated from the water turbine chamber;
a transmission module located outside the water turbine housing, with a first pulley and a second pulley, wherein the first pulley's axis is connected to the water turbine's axis and positioned outside the water turbine housing, while the second pulley's axis is positioned at an appropriate location corresponding to the gear box module and is connected to the gear box module, and the first and second pulleys are connected by a transmission component; and
a power generator module placed outside the water turbine housing and opposite to the second pulley, and axially connected to the gear box module;
a monitoring module electrically connected to the power generator module of the modular turbine for collecting hydropower generator data; and
a wireless communication module electrically connected to the monitoring module, capable of transmitting the hydropower generator data collected by the monitoring module to a remote control module;
wherein the remote control module is configured to monitor the hydropower generator data in real-time and send control instructions back to the monitoring module to control the power generator module, the water turbine housing is designed for easy removal or replacement of the water turbine and gear box module, and the transmission module and power generator module is configured to be easily removed or replaced.

2. The remote-controlled modular small hydropower generator system described in claim 1, wherein the power generator module is a direct current generator, and the monitoring module uses a grid-tied inverter to convert the direct current generated by the power generator module into alternating current and transmit it to the electrical grid.

3. The remote-controlled modular small hydropower generator system described in claim 1, wherein the power generator module is an alternating current generator, and the monitoring module transmits the alternating current generated by the power generator module to an electrical grid using a transformer.

4. The remote-controlled modular small hydropower generator system described in claim 1, wherein the monitoring module further has a multifunctional electric meter.

5. The remote-controlled modular small hydropower generator system described in claim 1, wherein the wireless communication module is a WIFI communication module.

6. The remote-controlled modular small hydropower generator system described in claim 1, wherein the wireless communication module is a mobile communication module.

7. The remote-controlled modular small hydropower generator system described in claim 1, wherein the transmission component of the modular turbine is a transmission belt.

8. The remote-controlled modular small hydropower generator system described in claim 1, wherein the first pulley and the second pulley are gears.

9. The remote-controlled modular small hydropower generator system described in claim 8, wherein the transmission component of the modular turbine is a transmission chain.

10. The remote-controlled modular small hydropower generator system described in claim 1, wherein the monitoring module is electrically connected to a battery module.
